(19) United States
(12) Patent Application Publication
(10) Pub. No.: US 2012/0006129 A1
(43) Pub. Date: Jan. 12, 2012

(54) PRESSURE MEASURING DEVICE

(75) Inventors: Tomohisa Tokuda, Tokyo (JP); Yuuichirou Sumiyoshi, Tokyo (JP)

(73) Assignee: YAMATAKE CORPORATION, Tokyo (JP)

(21) Appl. No.: 13/176,891

(22) Filed: Jul. 6, 2011

(30) Foreign Application Priority Data
Jul. 7, 2010 (JP) 2010-154933

(51) Int. Cl. G01L 1/22

(52) U.S. Cl. 73/862.629

(57) ABSTRACT

Provision of a pressure measuring device having a flexible membrane that receives the pressure; a pedestal, provided with a raised portion having a bottom face that is circular that supports the flexible membrane; and a supporting member that is bonded to the circular bottom face of the raised portion. The flexible membrane is made out of, for example, silicon, and has the (100) face as the primary face. Moreover, the flexible membrane is provided held between a silicon substrate, which is provided with a recessed portion, and a silicon substrate, which is provided with a recessed portion. Because of this, the flexible membrane is held on the pedestal with the silicon substrate interposed therebetween.

### CROSS REFERENCE TO RELATED APPLICATIONS

The present application claims priority under 35 U.S.C. §119 to Japanese Patent Application No. 2010-154933, filed Jul. 7, 2010, which is incorporated herein by reference.

### FIELD OF TECHNOLOGY

The present invention relates to a measuring technology, relating to a pressure measuring device.

### BACKGROUND OF THE INVENTION

Pressure measuring devices that use a semiconductor piezoresistance effect are small and light, and have high sensitivity, and thus are used broadly in factories, and the like (See, for example, Japanese Patent 3307281 and Japanese Unexamined Patent Application Publication 2006-170823). This type of pressure measuring device is provided with a strain gauge on a diaphragm made from a semiconductor. When the strain gauge deforms through pressure that acts on the diaphragm, the resistance value of the strain gauge will change due to the piezoresistance effect. As a result, the pressure can be measured by measuring the resistance value of the strain gauge.

In the pressure measuring device, if an external force other than the pressure that is subject to measurement is applied, then there may be error in the pressure measurement resulting from concentration of stresses in the contact surface of the structural components. Additionally, the mechanisms and structures proposed conventionally for alleviating the concentrated stresses have had problems in that they are complex and costly in terms of manufacturing. Given this, one object of the present invention is to provide a pressure measuring device able to measure pressure accurately by alleviating concentrated stresses.

### SUMMARY OF THE INVENTION

Examples of the present invention can be summarized as being a pressure measuring device having a flexible membrane that receives the pressure; a pedestal that is provided with a raised portion wherein the bottom face is circular, for supporting the flexible membrane; and a supporting member that is bonded to the circular bottom face of the raised portion. In the pressure measuring device according to this form of the present invention, the supporting member is secured to the pedestal through the raised portion having the circular bottom face, which is provided on the pedestal. Because of this, it is difficult for concentrated stresses to be produced in the bonding surface between the pedestal and the supporting member.

The present invention can provide a pressure measuring device able to measure pressure accurately.

### BRIEF DESCRIPTION OF THE DRAWINGS

FIG. 1 is a cross-sectional diagram of a pressure measuring device according to an example of the present invention.

FIG. 2 is a bottom face view of a pedestal according to an example.

FIG. 3 is a bottom face view of a first silicon substrate according to an example.

FIG. 4 is a top face view of a second silicon substrate according to an example of the present invention.

FIG. 5 is a top face view of a glass substrate according to an example of the present invention.

FIG. 6 is a top face view of a flexible membrane according to an example.

FIG. 7 is a cross-sectional diagram of a pressure measuring device according to another example.

FIG. 8 is a cross-sectional diagram of a pressure measuring device according to a further example.

### DETAILED DESCRIPTION OF THE INVENTION

Examples of the present invention are described below. In the descriptions of the drawings below, identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

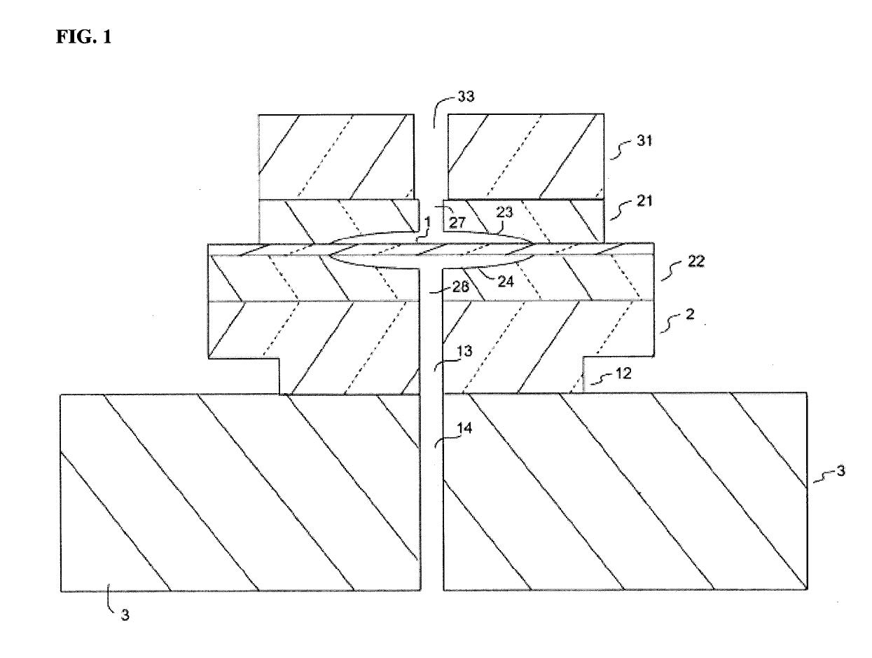

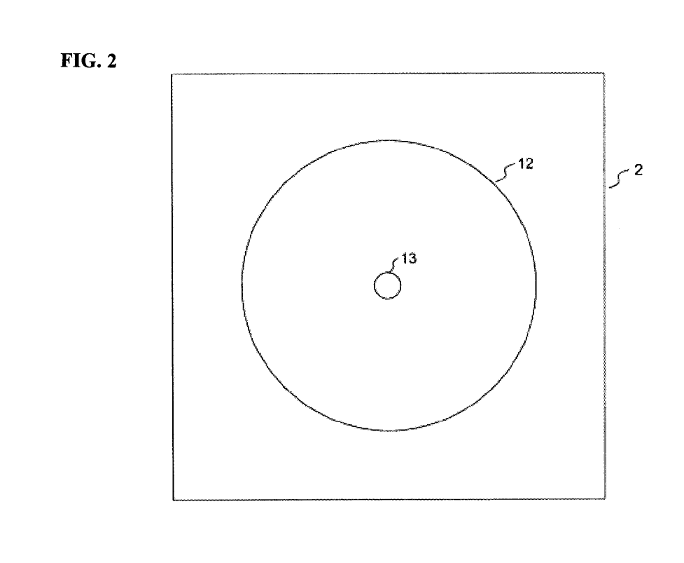

The pressure measuring device according to the example illustrated in FIG. 1, has a flexible membrane 1 that receives the pressure; a pedestal 2, provided with a raised portion 12 having a bottom face that is circular, as illustrated in FIG. 2, that supports the flexible membrane 1; and a supporting member 3, illustrated in FIG. 1, that is bonded to the circular bottom face of the raised portion 12. The flexible membrane 1 is made out of, for example, silicon, and has the (100) face as the primary face. Moreover, the flexible membrane 1 is provided held between a silicon substrate 21, which is provided with a recessed portion 23, and a silicon substrate 22, which is provided with a recessed portion, 24. The silicon substrate 22 is disposed on top of the pedestal 2. Because of this, the flexible membrane 1 is held on the pedestal 2 with the silicon substrate 22 interposed therebetween.

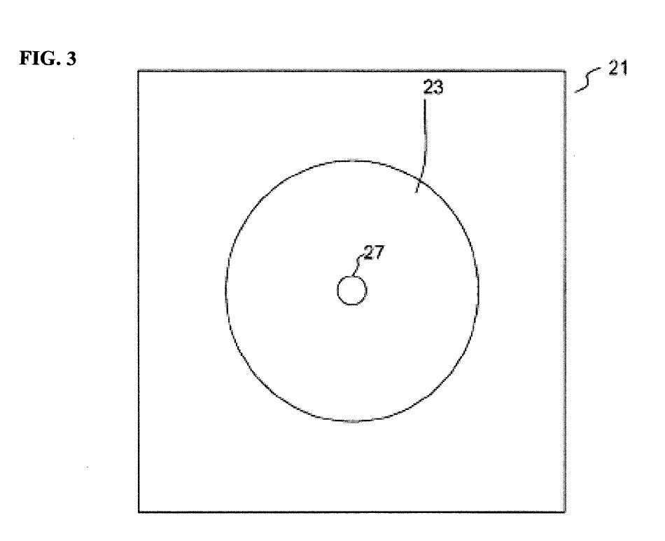

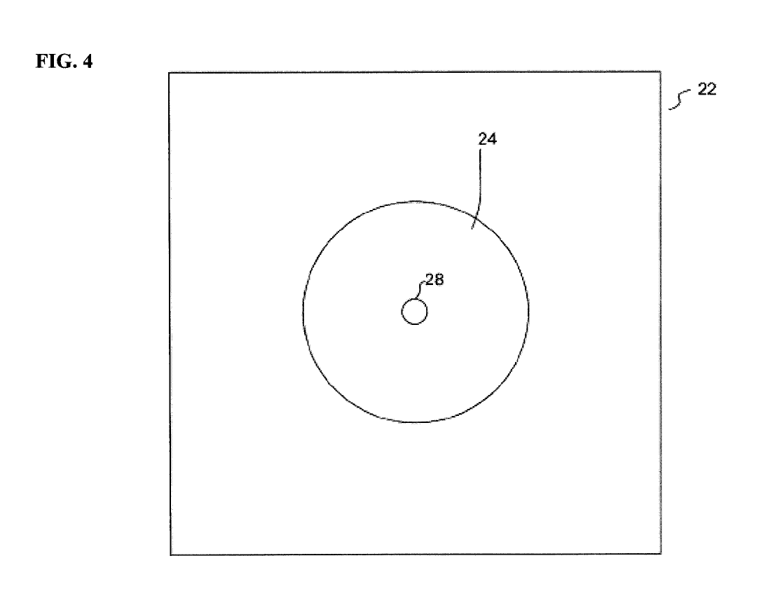

As illustrated in FIG. 1 and FIG. 3, the silicon substrate 21 is provided with a through hole 27 that passes through to the top face from the center of the recessed portion 23. As illustrated in FIG. 1 and FIG. 4, the silicon substrate 22 is provided with a through hole 28 that passes through to the bottom face from the center of the recessed portion 24.

For example, the outer periphery of the recessed portion 23 illustrated in FIG. 3 and the outer periphery of the recessed portion 24 illustrated in FIG. 4 are congruent. As illustrated in FIG. 1, the silicon substrate 21 and the silicon substrate 22 are disposed so that the positions of the outer periphery of the recessed portion 23 and the outer periphery of the recessed portion 24 in the crosswise direction match each other.

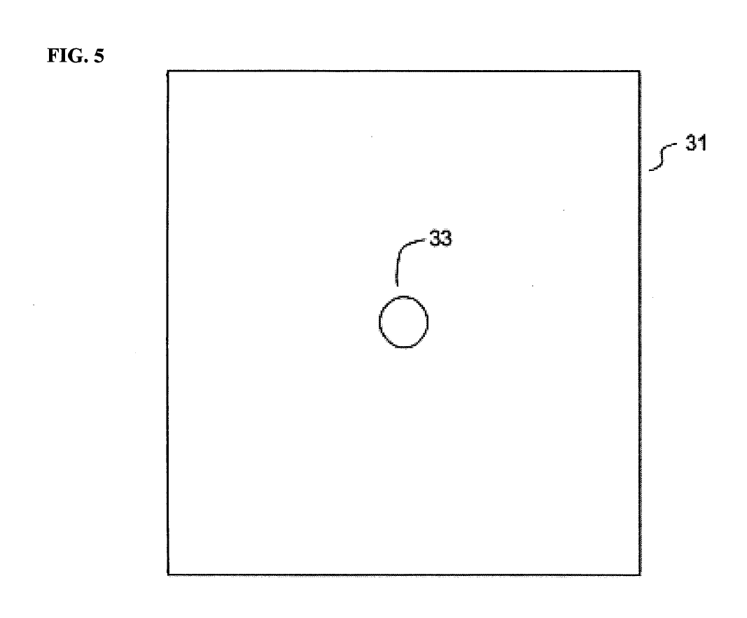

A glass substrate 31 may be disposed on top of the silicon substrate 21. As illustrated in FIG. 5, a through hole 33 is provided in the glass substrate 31 passing through to the through hole 27 of the silicon substrate 21. The pedestal 2 that is disposed on the bottom face of the silicon substrate 22, illustrated in FIG. 1, is made from glass (for example, TEMPAX Glass™), or the like. A through hole 13 that connects to the through hole 28 of the silicon substrate 22 is provided in the pedestal 2. The pedestal 2 that is provided with the raised portion 12 can be manufactured easily through, for example, a cutting process or an etching process. The supporting member 3 that is disposed so as to contact the bottom surface of the raised portion 12 of the pedestal 2 is made from stainless steel, or the like. A through hole 14 that connects to the through hole 13 of the pedestal 2 is provided in the supporting member 3. The supporting member 3 is, for example, a package that encloses the flexible membrane 1, and is not limited to being planar.

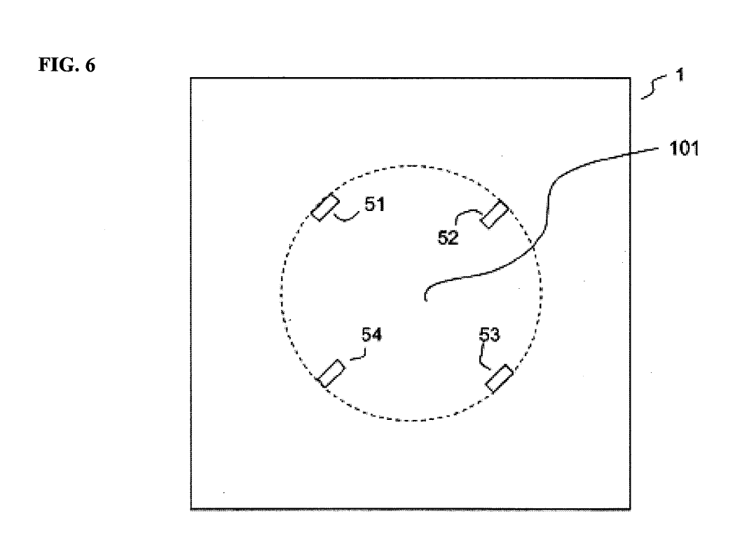

A circular part 101, illustrated in FIG. 6, that covers the recessed portion 23 and the recessed portion 24 of the flexible membrane 1, functions as a diaphragm for measuring the differential pressure between the pressure that is applied to the top surface and the pressure that is applied to the bottom surface. The circular portion 101 of the flexible membrane 1, which functions as the diaphragm for measuring differential pressure, is provided with strain resistance gauges 51, 52, 53, and 54 in the four (110) directions at 90° intervals. The electrical resistance values of the strain resistance gauges 51, 52, 53, and 54 will vary depending on the flexure of the flexible membrane 1 due to the differential pressure. Consequently, the differential pressure can be measured through measuring the electrical resistance values of the strain resistance gauges 51, 52, 53, and 54. The strain resistance gauges 51, 52, 53, and 54 may be fabricated through, for example, implantation of impurity ions into the flexible membrane 1 that is made from silicon.

In the pressure measuring device illustrated in FIG. 1, described above, the supporting member 3 is bonded in contact with the raised portion 12 that has the circular bottom face as illustrated in FIG. 2, provided on the pedestal 2. Because of this, it is difficult for concentrated stresses to be produced at the bonding surface between the pedestal 2 and the supporting member 3, which are made out of respectively different materials, when an outside force is applied to the supporting member 3. Consequently, it is unlikely that the bonding portion will break. Moreover, if the diameters are identical, the bonding surface area of a circle is smaller than that of a square, making it possible for the stresses themselves that are produced to be smaller, where the propagation of the stresses to the structure above can also be reduced through the constricted structure. Consequently, the measurement error produced through the propagation of these stresses can be suppressed in the pressure measuring device illustrated in FIG. 1. Moreover, it also less likely for the structures above to break due to the concentration of stresses.

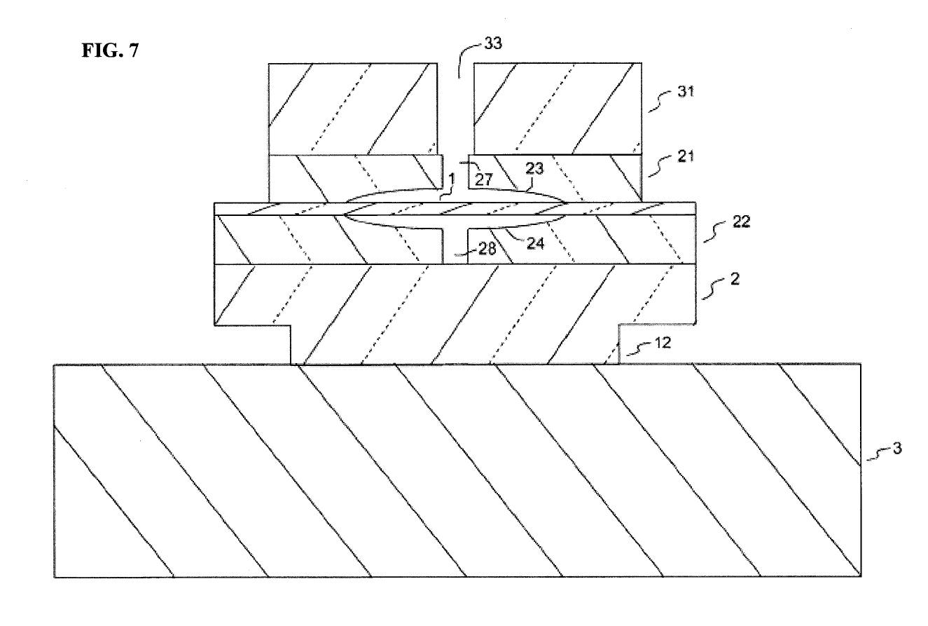

The pressure measuring device illustrated in FIG. 7 differs from the pressure measuring device illustrated in FIG. 1 in that no through hole is provided in the pedestal 2 and the supporting member 3. Because of this, the through hole 28 in the silicon substrate 22 is blocked by the pedestal 2. Because the recessed portion 24 of the silicon substrate 22 is also covered by the flexible membrane 1, the space formed by the recessed portion 24 of the silicon substrate 22 and the through hole 28 is closed. In this case, a constant reference pressure acts on the bottom face of the flexible membrane 1. Because of this, the pressure that is applied to the top surface of the flexible membrane 1 can be calculated easily from the differential pressure that is measured.

While there are descriptions of forms of embodiment as set forth above, the descriptions and drawings that form a portion of the disclosure are not to be understood to limit the present invention. A variety of alternate examples of embodiment and operating technologies should be obvious to those skilled in the art. For example, in the constraints on the supporting member bonded to the raised portion that has the circular base, provided on the pedestal, the pressure measuring device can assume a variety of forms.

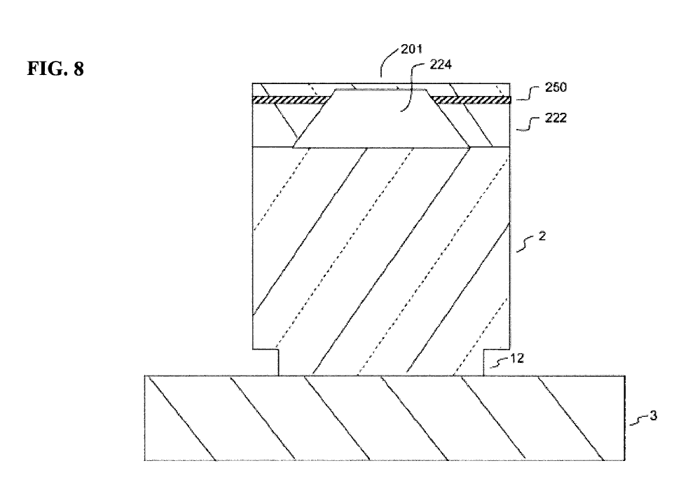

For example, the pressure measuring device illustrated in FIG. 8 may be manufactured from an SOI (Silicon on Insulator) substrate that includes a silicon substrate 222, a silicon oxide layer 250 that is disposed on the silicon substrate 222, and a silicon substrate 201 that is disposed on top of the silicon oxide layer 250. The recessed portion 224 may be provided through etching, or the like, from the silicon substrate 222 of the SOI substrate. The part wherein the recessed portion 224 reaches the silicon substrate 201 functions as the diaphragm for receiving the pressure. In the structure illustrated in FIG. 8, the supporting member 3 is bonded to the raised portion 12, having the circular bottom face, that is provided on the pedestal 2, thus making enabling an alleviation of the concentration of stresses at the bonding surface. In this way, the present invention should be understood to include a variety of forms of embodiment, and the like, not set forth herein.

1. A pressure measuring device comprising:
a flexible membrane for receiving pressure;
a pedestal, for supporting the flexible membrane, provided with a raised portion having a circular bottom face; and
a supporting member bonded to the circular bottom face of the raised portion.

2. The pressure measuring device as set forth in claim 1, wherein:
the pedestal is made out of glass and the supporting member is made out of metal.

3. The pressure measuring device as set forth in claim 1, wherein:
the pedestal supports the flexible membrane with a silicon substrate interposed therebetween.

4. The pressure measuring device as set forth in claim 3, wherein:
the silicon substrate is provided with a recessed portion that is covered by the flexible membrane.

5. The pressure measuring device as set forth in claim 1, wherein:
the flexible membrane is made out of silicon.

6. The pressure measuring device as set forth in claim 1, wherein:
a closed space is provided between the flexible membrane and the pedestal.
